(19) United States
(12) Patent Application Publication
(10) Pub. No.: US 2021/0303100 A1
(43) Pub. Date: Sep. 30, 2021

(54) DISPLAY MODULE AND DISPLAY DEVICE

(71) Applicant: WUHAN CHINA STAR OPTOELECTRONICS TECHNOLOGY CO., LTD., Wuhan, Hubei (CN)

(72) Inventor: Yaoli HUANG, Wuhan, Hubei (CN)

(21) Appl. No.: 16/625,730

(22) PCT Filed: Sep. 25, 2019
(86) PCT No.: PCT/CN2019/107784

§ 371 Date: Dec. 22, 2019

(30) Foreign Application Priority Data
Jul. 26, 2019 (CN) 201910679680.7

(51) Int. Cl. G06F 3/041; G06F 3/044; G09G 3/36

(52) U.S. Cl. CPC G06F 3/0418; G06F 3/0412; G09G 3/36; G06F 3/0443; G06F 3/04166

(57) ABSTRACT

The present invention provides a display module and a display device. The display module includes a touch panel, a touch driver chip, and a display driver chip. According to a randomized algorithm, a touch driver chip of the display module outputs a touch driving signal to touch electrodes and lets the touch driving signal no longer have a fixed frequency. The touch driving signal without the fixed frequency cannot match a natural frequency of film layers and generate resonance of the film layers between a grounded metal plate and the touch electrodes. Therefore, relieve a problem that the resonance of the film layers in current touch display devices.

### FIELD OF INVENTION

The present invention is related to the display field, and specifically to a display module and a display device.

### BACKGROUND OF INVENTION

With development of display technology, touch panels have become popular in our daily lives. A working principle of the touch panels is that a touch driver chip drives a periodic square wave signal to touch electrodes to detect a touch signal.

However, because a touch display device is provided with a grounded metal plate, parasitic capacitance is formed between the grounded metal plate and the touch electrodes. When the periodic square wave signal is input to the touch electrodes, the periodic square wave signal periodically charges and discharges the parasitic capacitance. Because of piezoelectric effect, the periodic square wave signal causes film layers between the grounded metal plate and the touch electrodes to vibrate. When a frequency of the periodic square wave signal is approximately equal to a natural frequency of the film layers, the film layers will generate resonance and vibrate with a large amplitude. The resonance of the film layers will cause themselves to peel off, resulting in poor display quality. In addition, the resonance of the film layers will cause the grounded metal plate to vibrate together, which generates high frequency noise and affects the user experience.

Therefore, there is a problem that the resonance of the film layers in current touch display devices needs to be solved.

### SUMMARY OF INVENTION

The present invention provides a display module and a display device to relieve the problem that the resonance of the film layers in current touch display devices.

In order to solve the above problem, technical solutions provided by the present invention are as follows:

The present invention provides a display module, including:

a touch panel including a display function layer and a touch function layer;

a touch driver chip for outputting a touch driving signal according to a randomized algorithm and detecting a touch operation by the touch function layer when outputting the touch driving signal; and

a display driver chip for driving the display function layer to display images.

In the display module provided by the present invention, the touch function layer is disposed in the display function layer.

In the display module provided by the present invention, the display function layer includes a common electrode layer, and the common electrode layer is patterned to form touch electrodes in the touch function layer.

In the display module provided by the present invention, the display function layer includes a pixel electrode layer, and the pixel electrode layer is patterned to form touch electrodes in the touch function layer.

In the display module provided by the present invention, the touch function layer is disposed outside the display function layer.

In the display module provided by the present invention, the touch function layer is disposed between the display function layer and a polarizer.

In the display module provided by the present invention, the touch function layer is disposed between the polarizer and a cover plate.

In the display module provided by the present invention, the touch driver chip is electrically connected to the display driver chip, and the display driver chip is further for detecting a touch signal and adjusting a display driving signal of a current frame when the touch signal is detected.

In the display module provided by the present invention, the touch driver chip and the display driver chip are the same chip.

In the display module provided by the present invention, adjusting the display driving signal of the current frame is to stop operation of the current frame.

Meanwhile, the present invention further provides a display device, including a display module, and the display module includes:

a touch panel including a display function layer and a touch function layer;

a touch driver chip for outputting a touch driving signal according to a randomized algorithm and detecting a touch operation by the touch function layer when outputting the touch driving signal; and

a display driver chip for driving the display function layer to display images.

In the display device provided by the present invention, the touch function layer is disposed in the display function layer.

In the display device provided by the present invention, the display function layer includes a common electrode layer, and the common electrode layer is patterned to form touch electrodes in the touch function layer.

In the display device provided by the present invention, the display function layer includes a pixel electrode layer, and the pixel electrode layer is patterned to form touch electrodes in the touch function layer.

In the display device provided by the present invention, the touch function layer is disposed outside the display function layer.

In the display device provided by the present invention, the touch function layer is disposed between the display function layer and a polarizer.

In the display device provided by the present invention, the touch function layer is disposed between the polarizer and a cover plate.

In the display device provided by the present invention, the touch driver chip is electrically connected to the display driver chip, and the display driver chip is further for detecting a touch signal and adjusting a display driving signal of a current frame when the touch signal is detected.

In the display device provided by the present invention, the touch driver chip and the display driver chip are the same chip.

In the display device provided by the present invention, adjusting the display driving signal of the current frame is to stop operation of the current frame.

The present invention provides a display module and a display device, according to a randomized algorithm, a touch driver chip of the display module outputs a touch driving signal to touch electrodes and lets the touch driving signal no longer have a fixed frequency. The touch driving signal without the fixed frequency cannot match a natural frequency of film layers and generate resonance of the film layers between a grounded metal plate and the touch electrodes. Therefore, relieve a problem that the resonance of the film layers in current touch display devices.

### DESCRIPTION OF DRAWINGS

In order to describe technical solutions in the present invention clearly, drawings to be used in the description of embodiments will be described briefly below. Apparently, drawings described below are only for some embodiments of the present invention, and other drawings may be obtained by those skilled in the art based on these drawings without creative efforts.

FIG. 1 is a touch driving sequence diagram of a current touch panel.

FIG. 2 is a structural diagram of a current display module generating parasitic capacitance.

FIG. 3 is a structural block diagram of a display module according to an embodiment of the present invention.

FIG. 4A is a first structural diagram of the display module according to an embodiment of the present invention.

FIG. 4B is a second structural diagram of the display module according to an embodiment of the present invention.

FIG. 5A is a first structural diagram of touch electrodes of the display module according to an embodiment of the present invention.

FIG. 5B is a second structural diagram of touch electrodes of the display module according to an embodiment of the present invention.

FIG. 6A is a first touch driving sequence diagram of the display module according to an embodiment of the present invention.

FIG. 6B is a second touch driving sequence diagram of the display module according to an embodiment of the present invention.

FIG. 7 is a third structural diagram of the display module according to an embodiment of the present invention.

### DETAILED DESCRIPTION OF PREFERRED EMBODIMENTS

Examples are described below with reference to the appended drawings, and the drawings illustrate particular embodiments in which the present invention may be practiced. Directional terms mentioned in the present invention, such as upper, lower, front, rear, left, right, in, out, side, etc., only refer to directions in the accompanying drawings. Thus, the adoption of directional terms is used to describe and understand the present invention, but not to limit the present invention. In the drawings, units of similar structures are represented using the same numerals.

Currently, touch panels can be classified according to their structure: out-cell touch panels, on-cell touch panels, and in-cell touch panels. The touch panels can also be classified according to their working principle: mutual-capacitance touch panels and self-capacitance touch panels. A mutual-capacitance touch panel generally includes a plurality of touch electrodes crossed with and insulated from a plurality of sensing electrodes. In order to let the mutual-capacitance touch panel implement a touch function, a touch driver chip sequentially applies a touch driving signal having a plurality of pulse signals to the plurality of touch electrodes. All the plurality of sensing electrodes receive a sensing signal at the same time, and it can obtain a capacitance of the two-dimensional plane of the entire mutual-capacitance touch panel. A position of a touch point is determined according to a change of the capacitance, thereby implementing the touch function. A self-capacitance touch panel generally includes a plurality of touch electrodes disposed in the same layer and insulated from each other. In order to let the self-capacitance touch panel implement a touch function, a touch driver chip applies a touch driving signal having a plurality of pulse signals to the plurality of touch electrodes. When the human body does not touch the touch panel, a capacitance of each of the plurality of touch electrodes is a fixed value. When the human body touches the touch panel, a capacitance of each of the plurality of touch electrodes is a capacitance of the human body superimposes on the fixed value. The touch driver chip can determine a touch position by detecting a change of the capacitance of each of the plurality of touch electrodes, thereby implementing the touch function.

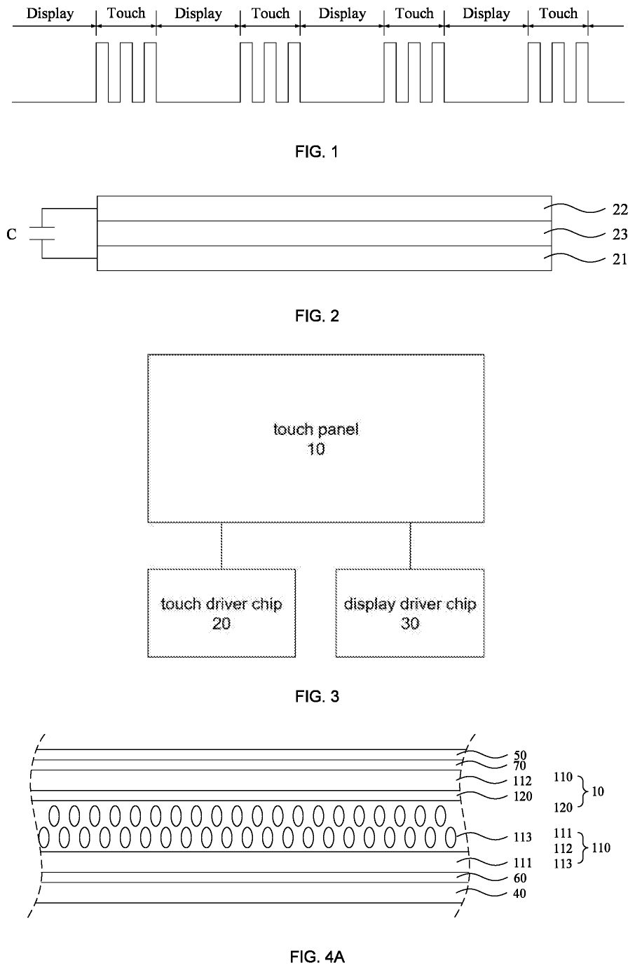

In the prior art, a touch panel uses a time-sharing driving method to prevent a display and a touch from interference to each other. As shown in FIG. 1, a touch driving sequence of the touch panel in one frame time is a periodic square wave signal, including alternating display driving phases and touch driving phases. In the display driving phases, a display driving signal applies a fixed voltage to display electrodes to let the touch panel implement displaying images. In the touch driving phases, a touch driving signal having a plurality of pulse signals is applied to the plurality of touch electrodes, and a change of parameters of each of the plurality of touch electrodes can be detected to determine a touch signal and let the touch panel implement a touch function.

As shown in FIG. 2, in a touch display device, a grounded metal plate 21 is disposed away from a light-emitting direction of the touch display device, and film layers 23 is disposed between the metal plate 21and touch electrodes 22. During implementation, parasitic capacitance is formed between the grounded metal plate 21 and the touch electrodes 22, a periodic touch driving signal periodically charges and discharges the parasitic capacitance when the periodic touch driving signal is applied to the touch electrodes 22, and parasitic electric field will be formed within the parasitic capacitance. The parasitic electric field causes polarization of the film layers 23 located in the parasitic electric field and causes electrostriction effect of it, and the film layers 23 vibrate. When a frequency of the periodic touch driving signal is approximately equal to a natural frequency of the film layers 23, the film layers 23 will generate resonance and vibrate with a large amplitude. The film layers 23 vibrate with a large amplitude will cause themselves and other film layers connecting thereto to peel off and even fall off, resulting in poor display quality of the touch display device. In addition, the resonance of the film layers connecting to the grounded metal plate 21 will cause the grounded metal plate 21 to vibrate together, which generates high frequency noise and affects the user experience.

The present invention provides a display module and a display device to relieve the problem that the resonance of the film layers in current touch display devices.

As shown in FIG. 3, the display module according to an embodiment of the present invention, including:

a touch panel 10 including a display function layer and a touch function layer;

a touch driver chip 20 for outputting a touch driving signal according to a randomized algorithm and detecting a touch operation by the touch function layer when outputting the touch driving signal; and

a display driver chip 30 for driving the display function layer to display images.

The present invention provides a display module and a display device, according to a randomized algorithm, a touch driver chip of the display module outputs a touch driving signal to touch electrodes and lets the touch driving signal no longer have a fixed frequency. The touch driving signal without the fixed frequency cannot match a natural frequency of film layers and generate resonance of the film layers between a grounded metal plate and the touch electrodes. Therefore, relieve a problem that the resonance of the film layers in current touch display devices.

During implementation, the touch panel can be a liquid crystal display panel or an organic light-emitting diode display panel, which is not limited herein. The following takes the liquid crystal display panel as an example and combines a specific embodiment to further describes the display module and the display device according to an embodiment of the present invention.

During implementation, the touch panel can be an out-cell touch panel, an on-cell touch panel, and an in-cell touch panel, which is not limited herein.

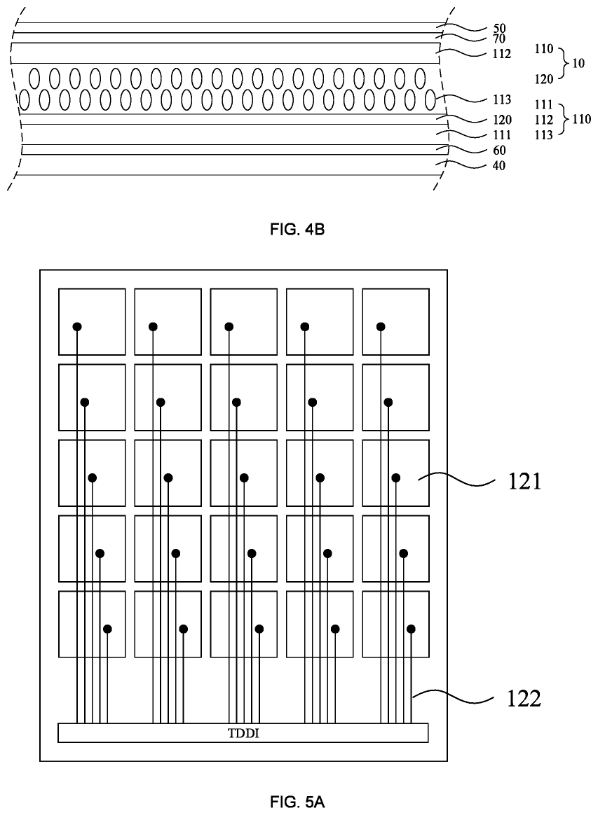

In an embodiment, as shown in FIGS. 4A and 4B, a touch panel 10 according to this embodiment includes a display function layer 110 and a touch function layer 120, and the touch function layer 120 is disposed in the display function layer 110.

In an embodiment, as shown in FIG. 4A, a touch display module includes a touch panel 10, a backlight module 40 disposed away from a light-emitting direction of the touch panel 10, a protective cover plate 50 disposed on the light-emitting direction of the touch panel 10, a first polarizer 60 disposed between the touch panel 10 and the backlight module 40, and a second polarizer 70 disposed between the touch panel 10 and the protective cover plate 50. The touch panel 10 includes a display function layer 110 and a touch function layer 120. The display function layer 110 includes an array substrate 111 disposed opposite to a color film substrate 112, and a liquid crystal layer 113 disposed between the array substrate 111 and the color film substrate 112. The color film substrate 112 includes a common electrode layer 1121, and the common electrode layer 1121 is patterned to form touch electrodes having common electrodes in the touch function layer 120, which means the common electrode layer 1121 and the touch function layer 120 are disposed in the same layer.

In this embodiment, the common electrode layer is disposed on a side of the color film substrate and patterned to form the touch electrodes having the common electrodes in the touch function layer. Likewise, the common electrode layer can be disposed on a side of the array substrate and patterned to form touch electrodes having the common electrodes in the touch function layer, which is not limited herein.

In an embodiment, common electrodes and touch electrodes are different electrodes, the common electrodes for providing a display driving signal to a touch panel are electrically connected to a display driver chip, and the touch electrodes for providing a touch driving signal to the touch panel are electrically connected to a touch driver chip. Meanwhile, the display driver chip can be electrically connected to the touch driver chip, the display driver chip is further for detecting a touch signal and adjusting the display driving signal of a current frame when the touch signal is detected. Adjusting the display driving signal of the current frame is to stop operation of the current frame or to reduce a voltage of the display driving signal, which is not limited herein.

In another embodiment, in order to simplify a circuit, common electrodes and touch electrodes are disposed as the same electrodes, which means the common electrodes are the touch electrodes, this time, the touch driver chip and the display driver chip are the same chip, which is a touch and display integration (TDDI), and the touch electrodes are electrically connected to the TDDI. In display driving phases of a touch panel, the TDDI applies a display driving signal to the touch panel through the touch electrodes. In touch driving phases, the TDDI applies a touch driving signal to the touch panel through the touch electrodes.

As shown in FIG. 5A, a transparent conducting layer used as common electrodes is divided into a plurality of blocks, which are touch electrodes 121, so the common electrodes is disposed as the touch electrodes. In this way, the touch driver chip and the display driver chip are the same chip, which is a touch and display integration (TDDI). The touch electrodes 121 are connected to the TDDI by touch lines 122 one-to-one corresponding to the touch electrodes 121.

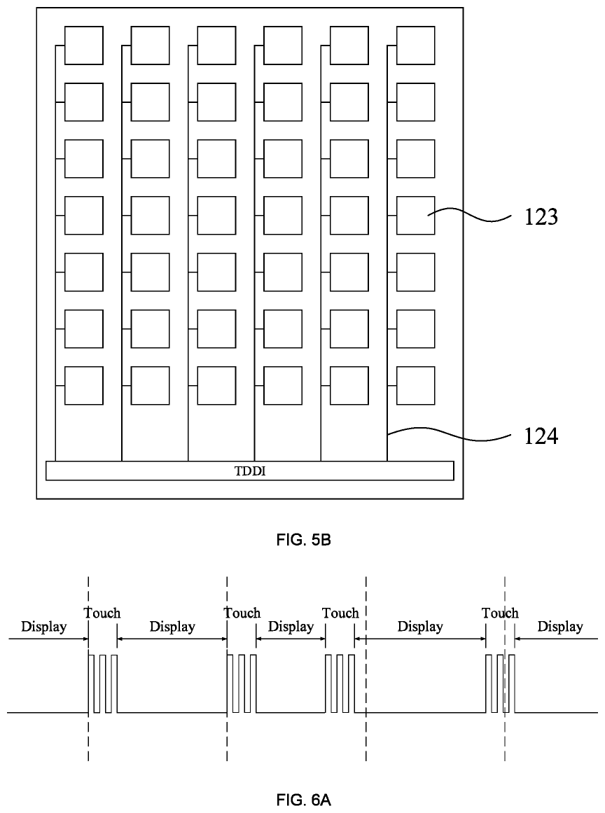

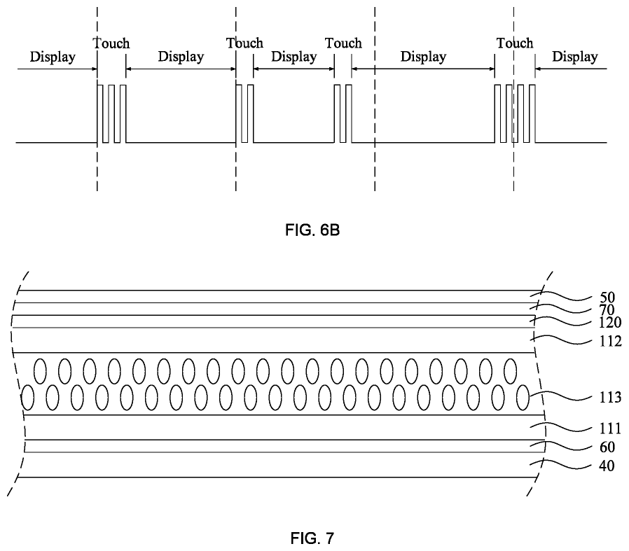

A touch panel uses a time-sharing driving method to prevent a display and a touch from interference to each other. As shown in FIGS. 6A and 6B, the touch panel includes alternating display driving phases and touch driving phases. In the display driving phases, a common voltage signal having a fixed voltage is applied to the touch electrodes 121 to let the touch panel display images. In the touch driving phases, a touch driving signal having a plurality of pulse signals is applied to the touch electrodes 121, and a touch signal obtained by each of the touch electrodes 121 can be detected to let the touch panel implement a touch function.

In order to make the touch driving signal no longer have a fixed frequency, a resonance of film layers between a ground metal plate and touch electrodes is no longer caused, and relieve a problem that the resonance of the film layers in current touch display devices, the present invention uses a randomized algorithm to determine a time period of outputting the touch driving signal, and the touch driving signal is outputted to the touch electrodes by the TDDI.

In an embodiment, the randomized algorithm for determining a time period of outputting the touch driving signal specifically includes: Selecting a limited time range, and uniformly dividing a display and touch timing of the touch panel by limited time ranges, as shown in FIGS. 6A and 6B, the limited time ranges are between dash lines. The limited time range can be a period of performing a display driving of one frame or any other selected period that longer than the period of performing the display driving of one frame or shorter than the period of performing the display driving of one frame. Randomly selecting a time point in the limited time ranges to output the touch driving signal to the touch electrodes, a number of selected time points is random, which can be one, two, zero, or multiple, but cannot exceed a number of rows of sub-pixels that can perform display driving within the limited time range. The touch driving signal is randomly output, it can be entire touch driving signal of performing a touch driving of one frame or a touch driving signal of performing part of the touch driving, but it needs to ensure that a previous period of the touch driving signal of performing part of the touch driving and a next period of the touch driving signal of performing part of the touch driving can be continuous. For example, the previous period of the touch driving signal of performing part of the touch driving is a touch driving signal corresponding to sub-pixels from third row to seventh row, and the next period of the touch driving signal of performing part of the touch driving is a touch driving signal corresponding to sub-pixels start from eighth row.

In another embodiment, the randomized algorithm for determining a time period of outputting the touch driving signal specifically includes: Randomly dividing a display driving time of each frames into a plurality of sub-display driving periods in order. For example, a display driving time of sub-pixels from first row to third row in the touch panel is a first sub-display driving period, a display driving time of sub-pixels from fourth row to ninth row is a second sub-display driving period, and is sequentially randomly divided downward. A number of the sub-display driving period can be one, multiple, or a last sub-display driving period of a pervious frame connected to a first sub-display driving period of a next frame. Likewise, randomly dividing a touch driving time of each frames into a plurality of sub-touch driving periods in order. A number of the sub-touch driving period can be one, or multiple. The divided sub-display driving periods and the sub-touch driving periods are alternately arranged in order to form a new display and touch driving timing, as shown in FIGS. 6A and 6B.

In an embodiment, as shown in FIG. 6A, in all touch driving phases, touch driving signals having the same pulse signal are applied to all touch electrodes by a touch and display integration (TDDI).

In another embodiment, as shown in FIG. 6B, it exists at least two touch driving phases, and touch driving signals having different pulse signals are applied to touch electrodes corresponding to these phases by a touch and display integration (TDDI).

In an embodiment, as shown in FIG. 4B, a touch display module includes a touch panel 10, a backlight module 40 disposed away from a light-emitting direction of the touch panel 10, a protective cover plate 50 disposed on the light-emitting direction of the touch panel 10, a first polarizer 60 disposed between the touch panel 10 and the backlight module 40, and a second polarizer 70 disposed between the touch panel 10 and the protective cover plate 50. The touch panel 10 includes a display function layer 110 and a touch function layer 120. The display function layer 110 includes an array substrate 111 disposed opposite to a color film substrate 112, and a liquid crystal layer 113 disposed between the array substrate 111 and the color film substrate 112. The array substrate 111 includes a pixel electrode layer 1111, the pixel electrode layer 1111 is patterned to form touch electrodes having pixel electrodes in the touch function layer 120, which means the pixel electrode layer 1111 and the touch function layer 120 are disposed in the same layer.

In this embodiment, the pixel electrode layer is disposed on a side of the array substrate and patterned to form the touch electrodes having the pixel electrode in the touch function layer. Likewise, the pixel electrode layer can be disposed on a side of the color film substrate and patterned to form touch electrodes having the pixel electrodes in the touch function layer, which is not limited herein.

In an embodiment, pixel electrodes and touch electrodes are different electrodes, the pixel electrodes for providing a display driving signal to a touch panel are electrically connected to a display driver chip, and the touch electrodes for providing a touch driving signal to the touch panel are electrically connected to a touch driver chip. Meanwhile, the display driver chip can be electrically connected to the touch driver chip, the display driver chip is further for detecting a touch signal and adjusting the display driving signal of a current frame when the touch signal is detected. Adjusting the display driving signal of the current frame is to stop operation of the current frame or to reduce a voltage of the display driving signal, which is not limited herein.

In another embodiment, in order to simplify a circuit, pixel electrodes and touch electrodes are disposed as the same electrodes, which means the pixel electrodes are the touch electrodes, this time, the touch driver chip and the display driver chip are the same chip, which is a touch and display integration (TDDI), and the touch electrodes are electrically connected to the TDDI. In display driving phases of a touch panel, the TDDI applies a display driving signal to the touch panel through the touch electrodes. In touch driving phases, the TDDI applies a touch driving signal to the touch panel through the touch electrodes.

The touch panel includes a plurality of sub-pixels for displaying images and a thin-film transistor and a pixel electrode corresponding to each of the plurality of sub-pixels. The thin-film transistor includes an active layer, a gate layer, and a source and drain layer. The gate layer is patterned to form a gate and a scan line for transmitting a scan signal of the gate, and one scan line corresponds to one line of the plurality of sub-pixels. The source and drain layer is patterned to form a source, a drain, and a data line for transmitting a data signal of the data line, and one data line corresponds to one line of the plurality of sub-pixels. The gate of the thin-film transistor is electrically connected to the corresponding scan line, the source is electrically connected to the corresponding data line, and the drain is electrically connected to the pixel electrode. The thin-film transistor is turned on under a control of the scan signal transmitted by the scan line, the data signal is transmitted to the pixel electrode by the data line, and the pixel electrode drives a pixel display.

As shown in FIG. 5B, the pixel electrodes are disposed as the touch electrodes. In this way, the touch driver chip and the display driver chip are the same chip, which is a touch and display integration (TDDI). The touch electrodes 121 are connected to the TDDI by data lines 124.

A touch panel uses a time-sharing driving method to prevent a display and a touch from interference to each other. As shown in FIGS. 6A and 6B, and is not described herein again. The touch panel includes alternating display driving phases and touch driving phases. In the display driving phases, a data voltage signal having a fixed voltage is applied to the touch electrodes to let the touch panel display images. In the touch driving phases, a touch driving signal having a plurality of pulse signals is applied to the touch electrodes, and a touch signal obtained by each of the touch electrodes can be detected to let the touch panel implement a touch function.

In order to make the touch driving signal no longer have a fixed frequency, a resonance of film layers between a ground metal plate and touch electrodes is no longer caused, and relieve a problem that the resonance of the film layers in current touch display devices, the present invention uses a randomized algorithm to determine a time period of outputting the touch driving signal, and the touch driving signal is outputted to the touch electrodes by the TDDI. A specific operation of using the randomized algorithm to determine the time period of outputting the touch driving signal can be made by the foregoing embodiments, and is not described herein again.

In an embodiment, a touch panel 10 according to an embodiment of the present invention includes a display function layer 110 and a touch function layer 120, and the touch function layer 120 is disposed outside the display function layer 110.

In an embodiment, as shown in FIG. 7, a touch display module includes a touch panel 10, a backlight module 40 disposed away from a light-emitting direction of the touch panel 10, a protective cover plate 50 disposed on the light-emitting direction of the touch panel 10, a first polarizer 60 disposed between the touch panel 10 and the backlight module 40, a second polarizer 70 disposed between the touch panel 10 and the protective cover plate 50, and a touch layer is patterned to form touch electrodes. The touch electrodes are connected to a touch driver chip by touch lines one-to-one corresponding to the touch electrodes.

In order to make a touch driving signal no longer have a fixed frequency, a resonance of film layers between a ground metal plate and touch electrodes is no longer caused, and relieve a problem that the resonance of the film layers in current touch display devices, the present invention uses a randomized algorithm to determine a time period of outputting the touch driving signal, and the touch driving signal is outputted to the touch electrodes by the touch driver chip. A specific operation can be made by the foregoing embodiments, and is not described herein again.

Meanwhile, the present invention also provides a display device, including a display module. The display module includes:

a touch panel including a display function layer and a touch function layer;

a touch driver chip for outputting a touch driving signal according to a randomized algorithm and detecting a touch operation by the touch function layer when outputting the touch driving signal; and

a display driver chip for driving the display function layer to display images.

A display device according to an embodiment of the present invention includes a display module, according to a randomized algorithm, a touch driver chip of the display module outputs a touch driving signal to touch electrodes and lets the touch driving signal no longer have a fixed frequency. The touch driving signal without the fixed frequency cannot match a natural frequency of film layers and generate resonance of the film layers between a grounded metal plate and the touch electrodes. Therefore, relieve a problem that the resonance of the film layers in current touch display devices.

In an embodiment, the touch function layer is disposed in the display function layer.

In an embodiment, the display function layer includes a common electrode layer, and the common electrode layer is patterned to form touch electrodes in the touch function layer.

In an embodiment, the display function layer includes a pixel electrode layer, and the pixel electrode layer is patterned to form touch electrodes in the touch function layer.

In an embodiment, the touch function layer is disposed outside the display function layer.

In an embodiment, the touch function layer is disposed between the display function layer and a polarizer.

In an embodiment, the touch function layer is disposed between the polarizer and a cover plate.

In an embodiment, the touch driver chip is electrically connected to the display driver chip, and the display driver chip is further for detecting a touch signal and adjusting a display driving signal of a current frame when the touch signal is detected.

In an embodiment, the touch driver chip and the display driver chip are the same chip.

In an embodiment, adjusting the display driving signal of the current frame is to stop operation of the current frame.

In an embodiment, adjusting the display driving signal of the current frame is to reduce a voltage of the display driving signal.

According to the forgoing embodiments:

The present invention provides a display module and a display device. The display module includes a touch panel including a display function layer and a touch function layer; a touch driver chip for outputting a touch driving signal according to a randomized algorithm and detecting a touch operation by the touch function layer when outputting the touch driving signal; and a display driver chip for driving the display function layer to display images. According to a randomized algorithm, a touch driver chip of the display module outputs a touch driving signal to touch electrodes and lets the touch driving signal no longer have a fixed frequency. The touch driving signal without the fixed frequency cannot match a natural frequency of film layers and generate resonance of the film layers between a grounded metal plate and the touch electrodes. Therefore, relieve a problem that the resonance of the film layers in current touch display devices.

Although the present invention has been disclosed above by the preferred embodiments, the preferred embodiments are not intended to limit the invention. One of ordinary skill in the art, without departing from the spirit and scope of the present invention, can make various modifications and variations of the present invention. Therefore, the scope of the claims to define the scope of equivalents.

What is claimed is:

1. A display module, comprising:
a touch panel comprising a display function layer and a touch function layer;
a touch driver chip for outputting a touch driving signal according to a randomized algorithm and detecting a touch operation by the touch function layer when outputting the touch driving signal; and
a display driver chip for driving the display function layer to display images.

2. The display module as claimed in claim 1, wherein the touch function layer is disposed in the display function layer.

3. The display module as claimed in claim 2, wherein the display function layer comprises a common electrode layer, and the common electrode layer is patterned to form touch electrodes in the touch function layer.

4. The display module as claimed in claim 2, wherein the display function layer comprises a pixel electrode layer, and the pixel electrode layer is patterned to form touch electrodes in the touch function layer.

5. The display module as claimed in claim 1, wherein the touch function layer is disposed outside the display function layer.

6. The display module as claimed in claim 5, wherein the touch function layer is disposed between the display function layer and a polarizer.

7. The display module as claimed in claim 5, wherein the touch function layer is disposed between the polarizer and a cover plate.

8. The display module as claimed in claim 2, wherein the touch driver chip is electrically connected to the display driver chip, and the display driver chip is further for detecting a touch signal and adjusting a display driving signal of a current frame when the touch signal is detected.

9. The display module as claimed in claim 8, wherein the touch driver chip and the display driver chip are the same chip.

10. The display module as claimed in claim 8, wherein adjusting the display driving signal of the current frame is to stop operation of the current frame.

11. A display device, comprising a display module, and the display module comprises:
a touch panel comprising a display function layer and a touch function layer;
a touch driver chip for outputting a touch driving signal according to a randomized algorithm and detecting a touch operation by the touch function layer when outputting the touch driving signal; and
a display driver chip for driving the display function layer to display images.

12. The display device as claimed in claim 11, wherein the touch function layer is disposed in the display function layer.

13. The display device as claimed in claim 12, wherein the display function layer comprises a common electrode layer, and the common electrode layer is patterned to form touch electrodes in the touch function layer.

14. The display device as claimed in claim 12, wherein the display function layer comprises a pixel electrode layer, and the pixel electrode layer is patterned to form touch electrodes in the touch function layer.

15. The display device as claimed in claim 11, wherein the touch function layer is disposed outside the display function layer.

16. The display device as claimed in claim 15, wherein the touch function layer is disposed between the display function layer and a polarizer.

17. The display device as claimed in claim 15, wherein the touch function layer is disposed between the polarizer and a cover plate.

18. The display device as claimed in claim 12, wherein the touch driver chip is electrically connected to the display driver chip, and the display driver chip is further for detecting a touch signal and adjusting a display driving signal of a current frame when the touch signal is detected.

19. The display device as claimed in claim 18, wherein the touch driver chip and the display driver chip are the same chip.

20. The display device as claimed in claim 18, wherein adjusting the display driving signal of the current frame is to stop operation of the current frame.
